(19) United States
(12) Patent Application Publication
(10) Pub. No.: US 2025/0356623 A1
(43) Pub. Date: Nov. 20, 2025

(54) METHOD AND APPARATUS FOR AUGMENTING VISUAL FEATURE

(71) Applicant: POSTECH RESEARCH AND BUSINESS DEVELOPMENT FOUNDATION, Pohang-si (KR)

(72) Inventors: Taehyun OH, Pohang-si (KR); Ye-Bin MOON, Pohang-si (KR); Hongyeob KIM, Pohang-si (KR); Jisoo KIM, Pohang-si (KR)

(73) Assignee: POSTECH RESEARCH AND BUSINESS DEVELOPMENT FOUNDATION, Pohang-si (KR)

(21) Appl. No.: 19/041,594

(22) Filed: Jan. 30, 2025

(30) Foreign Application Priority Data
May 20, 2024 (KR) 10-2024-0065444

(51) Int. Cl. G06V 10/764; G06V 10/40; G06V 10/77; G06V 20/70

(52) U.S. Cl. CPC G06V 10/764; G06V 10/40; G06V 10/7715; G06V 20/70

(57) ABSTRACT

There is provided a method for augmenting a visual feature, comprising: extracting a visual feature from an input image; embedding into a text space respectively, a class of the input image and an attribute class formed by reflecting attribute information onto the class; calculating a difference vector between an embedded vector of the class and an embedded vector of the attribute class; and augmenting the visual feature corresponding to the input image based on the difference vector, wherein the apparatus includes: an encoder that extracts the visual feature from the input image; and a predictor that generates predicted class of the input image based on the augmented the visual feature in order to compare whether the predicted class is matched with the class of the input image.

### CROSS REFERENCE TO RELATED APPLICATION

The present application claims priority to Korean Patent Application No. 10-2024-0065444, filed on May 20, 2024, the entire contents of which are incorporated herein by reference for all purposes.

### TECHNICAL FIELD

Embodiments relate to a method and apparatus for augmenting a visual feature. This work was supported by Institute of Information & communications Technology Planning & Evaluation (IITP) grant funded by the Korea government (MSIT) (No.RS-2022-II220290 (2022-0-00290), Visual Intelligence for Space-Time Understanding and Generation based on Multi-layered Visual Common Sense; No. RS-2024-00457882, National AI Research Lab Project; No.RS-2021-II212068, Artificial Intelligence Innovation Hub).

### BACKGROUND

Conventionally used visual data augmentation methods, a method of semantically adding perturbation to visual features by interpolating labels has been used.

As one of the visual data augmentation methods, a method of interpolating the entire two input images on a pixel-by-pixel basis is used, and as another visual data augmentation methods, a method of interpolating a partial area of one image with another image is used. Since the interpolation-based method interpolates class labels along with interpolating images, it is possible to augment sample labels through semantic perturbation between classes.

The visual data augmentation method described above includes a process of sampling two samples from a population during the process of interpolating images and labels of two samples. This process may affect the class distribution. For example, in the case of a long-tailed distribution with imbalanced class-specific training data, the sampling probabilities differ between classes with a large amount of data and classes with a small amount of data, which may lead to biased sampling for a main class with a large amount of data, thereby resulting in poor performance of a classifier. Therefore, there is a limit in that the interpolation-based visual data augmentation method may be effectively used only when the distribution of the classes is balanced and the number of samples is large.

### SUMMARY OF THE INVENTION

An embodiment may provide a method and apparatus for augmenting a visual feature corresponding to an input image based on a difference vector calculated between a class of an input image and an attribute class that reflects attribute information in the class.

However, the problem to be solved by the present disclosure is not limited to that mentioned above, and other problems to be solved that are not mentioned may be clearly understood by those of ordinary skill in the art to which the present disclosure belongs from the following description.

In accordance with an aspect of the present disclosure, there is provided a method for augmenting a visual feature, comprising: extracting a visual feature from an input image; embedding into a text space respectively, a class of the input image and an attribute class formed by reflecting attribute information onto the class; calculating a difference vector between an embedded vector of the class and an embedded vector of the attribute class; and augmenting the visual feature corresponding to the input image based on the difference vector, wherein the apparatus includes: an encoder that extracts the visual feature from the input image; and a predictor that generates predicted class of the input image based on the augmented the visual feature in order to compare whether the predicted class is matched with the class of the input image.

The method may further comprise projecting the difference vector into a visual space, wherein, in the augmenting, the visual feature may be augmented using the projected difference vector.

In the projecting, the difference vector may be linearly projected into the visual space.

In the augmenting, the visual feature may be augmented based on a value obtained by multiplying the projected difference vector by a weight and the visual feature.

The augmented visual feature may be determined as \hat{f}_{I0}=fₘ+α·proj(Δ_{0→1}). Here, \hat{f}ₘ may denote the augmented visual feature, f_{I0} may denote the visual feature, α may denote the weight, and proj(Δ_{0→1}) may denote the projected difference vector.

The class may include text information, and the attribute information may include visual information reflected in the text information.

The visual information may include at least one of a size, a color, and a pattern.

The method may further comprise prior to the embedding, receiving the attribute class in which the attribute information is reflected.

The encoder and the predictor may be pre-trained using the input image and the class corresponding to the input image as label data.

The method may further comprise generating an augmented image based on the augmented visual feature and the class.

The method may further comprise training at least one of the encoder and the predictor using the augmented image and the class corresponding to the augmented image as label data.

In accordance with another aspect of the present disclosure, there is provided an apparatus for augmenting a visual feature, the apparatus comprising: a memory storing computer-executable instructions; and a processor for executing the instructions to: extract a visual feature from an input image; embed into a text space respectively, a class of the input image and an attribute class formed by reflecting attribute information onto the class; calculate a difference vector between an embedded vector of the class and an embedded vector of the attribute class; and augment the visual feature corresponding to the input image based on the difference vector, wherein the apparatus further includes: an encoder that extracts the visual feature from the input image; and a predictor that generates predicted class of the input image based on the augmented the visual feature in order to compare whether the predicted class is matched with the class of the input image.

In accordance with another aspect of the present disclosure, there is provided a non-transitory computer-readable storage medium storing a computer program, wherein the computer program, when executed by a processor, comprises an instruction for causing the processor to perform a method comprises extracting a visual feature from an input image; embedding into a text space respectively, a class of the input image and an attribute class formed by reflecting attribute information onto the class; calculating a difference vector between an embedded vector of the class and an embedded vector of the attribute class; and augmenting the visual feature corresponding to the input image based on the difference vector, wherein the apparatus includes: an encoder that extracts the visual feature from the input image; and a predictor that generates predicted class of the input image based on the augmented the visual feature in order to compare whether the predicted class is matched with the class of the input image.

According to the present invention, the semantic perturbation for data can be generated from the classes, such as text information, and then projected and injected into the visual space. As a result, it is possible to augment data with the human-readable text information even when there are few training images.

In addition, it is possible to provide a visual data augmentation method that can be uniformly applied to all samples regardless of class distribution.

In addition, by injecting the semantic perturbation into the sample features at a level within the class boundary that does not change the label, it is possible to densify the feature space. Accordingly, it is possible to improve the performance of the classifier even in the case of not only in cases of distributions where training data is small, but also in cases of long-tailed distribution with imbalanced class-specific training data.

In addition, the classifier can be further improved by combining it with the existing interpolation-based method.

In addition, the present invention can be applied to all systems that perform image object classification, such as medical image classification, plant growth monitoring, classification of recycling types, classification of objects in surveillance lists such as weapons and explosives, and classification of product quality anomalies during the manufacturing process.

### BRIEF DESCRIPTION OF THE DRAWINGS

FIG. 1 is a flowchart exemplarily illustrating a method of augmenting a visual feature according to a first aspect of the present invention.

FIG. 2 is a block diagram exemplarily illustrating an apparatus for augmenting a visual feature according to a second aspect of the present invention.

FIG. 3 is a block diagram exemplarily illustrating the function of the visual feature augmentation program.

FIG. 4 is a flowchart exemplarily illustrating the method for generating training data of an AI model according to another embodiment of the first aspect of the present invention.

FIG. 5 is a block diagram exemplarily illustrating an apparatus for generating training data according to another embodiment of a second aspect of the present invention.

FIG. 6 is a block diagram exemplarily illustrating the function of the training data generation program.

FIG. 7 is an exemplary diagram illustrating a pipeline that performs the method of augmenting a visual feature of the present invention.

FIG. 8 is an exemplary diagram that visualizes and illustrates the difference vector representing various attributes when the difference vector is projected into the visual space.

FIG. 9 is an exemplary diagram illustrating the visualization of the semantic perturbation of the method of augmenting a visual feature according to the present invention through image manipulation.

FIG. 10 is a table showing the image classification performance for a case of a long-tailed distribution with an imbalanced class-specific training data.

FIG. 11 is an exemplary diagram illustrating the image classification performance when the training data distribution is even but the number is small.

FIG. 12 is a table showing the object detection performance when the number of samples is very small, from 1 to 10.

FIG. 13 is a table showing the classification performance results when linearly probing the classifier of the pre-trained model on new data generated according to the method of augmenting a visual feature according to the present invention.

### DETAILED DESCRIPTION OF THE INVENTION

The advantages and features of the embodiments and the methods of accomplishing the embodiments will be clearly understood from the following description taken in conjunction with the accompanying drawings. However, embodiments are not limited to those embodiments described, as embodiments may be implemented in various forms. It should be noted that the present embodiments are provided to make a full disclosure and also to allow those skilled in the art to know the full range of the embodiments. Therefore, the embodiments are to be defined only by the scope of the appended claims.

Terms used in the present specification will be briefly described, and the present disclosure will be described in detail.

In terms used in the present disclosure, general terms currently as widely used as possible while considering functions in the present disclosure are used. However, the terms may vary according to the intention or precedent of a technician working in the field, the emergence of new technologies, and the like. In addition, in certain cases, there are terms arbitrarily selected by the applicant, and in this case, the meaning of the terms will be described in detail in the description of the corresponding invention. Therefore, the terms used in the present disclosure should be defined based on the meaning of the terms and the overall contents of the present disclosure, not just the name of the terms.

When it is described that a part in the overall specification “includes” a certain component, this means that other components may be further included instead of excluding other components unless specifically stated to the contrary.

In addition, a term such as a “unit” or a “portion” used in the specification means a software component or a hardware component such as FPGA or ASIC, and the “unit” or the “portion” performs a certain role. However, the “unit” or the “portion” is not limited to software or hardware. The “portion” or the “unit” may be configured to be in an addressable storage medium, or may be configured to reproduce one or more processors. Thus, as an example, the “unit” or the “portion” includes components (such as software components, object-oriented software components, class components, and task components), processes, functions, properties, procedures, subroutines, segments of program code, drivers, firmware, microcode, circuits, data, database, data structures, tables, arrays, and variables. The functions provided in the components and “unit” may be combined into a smaller number of components and “units” or may be further divided into additional components and “units”.

Hereinafter, the embodiment of the present disclosure will be described in detail with reference to the accompanying drawings so that those of ordinary skill in the art may easily implement the present disclosure. In the drawings, portions not related to the description are omitted in order to clearly describe the present disclosure.

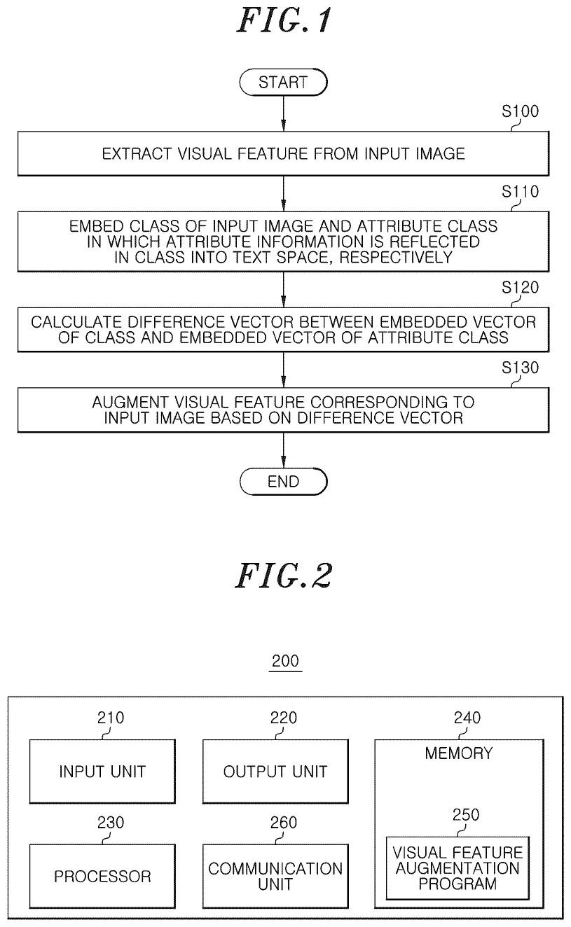

FIG. 1 is a flowchart exemplarily illustrating a method of augmenting a visual feature according to a first aspect of the present invention. Hereinafter, the method of augmenting a visual feature will be described on the assumption that the method is performed by an apparatus for augmenting a visual feature.

As illustrated in FIG. 1, the method of augmenting a visual feature according to the first aspect of the present invention includes a step (S100) of extracting a visual feature from an input image, a step (S110) of embedding a class of the input image and an attribute class in which attribute information is reflected in the class into a text space, respectively, a step (S120) of calculating a difference vector between an embedded vector of the class and an embedded vector of the attribute class, and a step (S130) of augmenting the visual feature corresponding to the input image based on the difference vector.

The input image may be data for training or inference of an artificial intelligence (AI) model performing a predetermined task. Here, the predetermined task may be one of image classification, object detection, and object recognition. In this case, the AI model may include an encoder that extracts the visual feature from the input image, and a predictor that recognizes the input image based on the visual feature.

The class corresponds to the input image and may include text information. As the training data for the AI model, the input image and the class corresponding to the input image may be used as label data. In other words, the AI model may be trained using the input image and the class corresponding to the input image as the label data. In this case, only some of the encoder and predictor included in the AI model may be selected and trained, or both the encoder and predictor may be selected and trained.

In addition, an augmented image may be generated based on the augmented visual feature, and at least one of the encoder and predictor may be trained using the augmented image and the class corresponding to the augmented image as the label data. In this case, the class used as the label data in an original input image may also be used as the label data even in the augmented image.

FIG. 2 is a block diagram exemplarily illustrating an apparatus for augmenting a visual feature according to a second aspect of the present invention.

As illustrated in FIG. 2, an apparatus 200 for augmenting a visual feature may include an input unit 210, an output unit 220, a processor 230, a memory 240, and a communication unit 260.

Hereinafter, for the convenience of description, it will be described as an example that the apparatus 200 for augmenting a visual feature includes the input unit 210, the output unit 220, the processor 230, the memory 240, and the communication unit 260, but the present invention is not limited thereto. That is, each unit configuration may be provided outside the apparatus 200 for augmenting a visual feature and may operate in a manner that interacts with the apparatus 200 for augmenting a visual feature.

The input unit 210 may include a user interface that receives commands, information, etc., that are used to control the apparatus 200 for augmenting a visual feature. In addition, the input unit 210 may be hardware devices (e.g., a keyboard, a mouse, a touch pad, etc.) that may directly receive the commands, the information, etc., that are used to control the apparatus 200 for augmenting a visual feature.

In an embodiment, the input unit 210 may receive information required for the method of augmenting a visual feature from a user. Specifically, the user may input information that includes the input image, the class, the attribute class, an augmented image, and parameters related to the AI model through the input unit 210.

The output unit 220 may provide, as visual information, information that includes the input image, the class, the attribute class, the difference vector, the projected difference vector, the visual feature, the augmented visual feature, the augmented image, and the parameters related to the AI model, to a user through an interface or a display device.

The processor 230 may control the overall operation of the apparatus 200 for augmenting a visual feature to perform the present invention.

The processor 230 may load a visual feature augmentation program 250 and information necessary for executing the visual feature augmentation program 250 from the memory 240 in order to execute the visual feature augmentation program 250.

The processor 230 may control data received from an external device through the communication unit 260 to be stored in the memory 240. In addition, the processor 230 may control to transmit and receive the information that includes the input image, the class, the attribute class, the difference vector, the projected difference vector, the visual feature, the augmented visual feature, the augmented image, and the parameters related to the AI model to and from the external device through the communication unit 260.

The processor 230 may refer to processing devices such as a microprocessor, a central processing unit (CPU), a graphic processing unit (GPU), a processor core, a multiprocessor, an application-specific integrated circuit (ASIC), a field programmable gate array (FPGA), or a micro controller unit (MCU), but is not limited to the above-described embodiment.

The memory 240 may store the visual feature augmentation program 250 and the information necessary for executing the visual feature augmentation program 250. In addition, the memory 240 may also store processing results by the processor 230.

The visual feature augmentation program 250 may refer to software including instructions programmed to perform the method according to the present invention.

The memory 240 may store the information that includes the input image, the class, the attribute class, the difference vector, the projected difference vector, the visual feature, the augmented visual feature, the augmented image, and the parameter related to the AI model. In addition, the memory 240 may store the information received from the external device through the communication unit 260.

The memory 240 may refer to computer-readable recording media, such as magnetic media such as a hard disk, a floppy disk, and a magnetic tape, optical media such as a CD-ROM and a DVD, magneto-optical media such as a floptical disk, random access memories such as a dynamic random access memory (DRAM) and a static random access memory (SRAM), and a hardware device specifically configured to store and execute program instructions such as a flash memory, but is not limited to the above-described embodiments.

The communication unit 260 may be a wireless communication module capable of performing wireless communication by employing communication methods such as CDMA, GSM, W-CDMA, TD-SCDMA, WiBro, LTE, EPC, 5G, wireless LAN, Wi-Fi, Bluetooth, Zigbee, Wi-Fi direct (WFD), ultra wide band (UWB), infrared data association (IrDA), Bluetooth low energy (BLE), or near field communication (NFC), but is not limited to the above-described embodiment.

In addition, information input and output through the input unit 210 and the output unit 220, information stored in the memory 240, and information transmitted and received through the communication unit 260 include all information related to the present invention, and are not limited to the above-described embodiment.

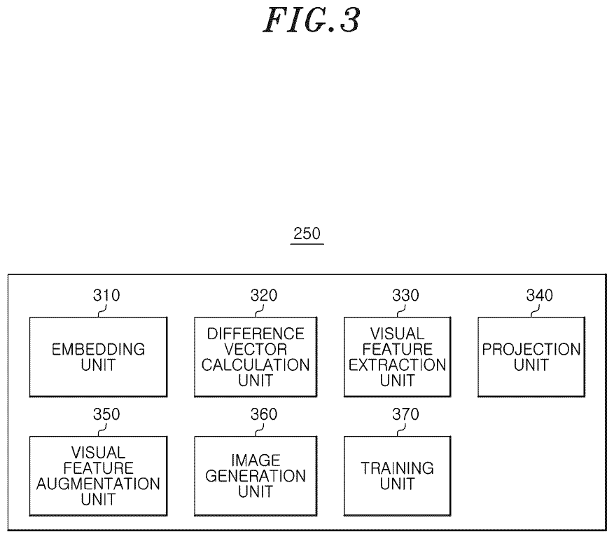

The function or operation of the visual feature augmentation program 250 will be described in detail with reference to FIG. 3.

FIG. 3 is a block diagram exemplarily illustrating the function of the visual feature augmentation program.

As illustrated in FIG. 3, the visual feature augmentation program 250 may include an embedding unit 310, a difference vector calculation unit 320, a visual feature extraction unit 330, a projection unit 340, a visual feature augmentation unit 350, an image generation unit 360, and a training unit 370. The embedding unit 310, the difference vector generation unit 320, the visual feature extraction unit 330, the projection unit 340, the visual feature augmentation unit 350, the image generation unit 360, and the training unit 370 are exemplary division of the functions of the visual feature augmentation program 250, but are not limited thereto.

According to an embodiment, the functions of each of the embedding unit 310, the difference vector generation unit 320, the visual feature extraction unit 330, the projection unit 340, the visual feature augmentation unit 350, the image generation unit 360, and the training unit 370 can be merged/separated, and may be implemented as a series of instructions included in at least one program.

The embedding unit 310, the difference vector calculation unit 320, the visual feature extraction unit 330, the projection unit 340, the visual feature augmentation unit 350, the image generation unit 360, and the training unit 370 may be implemented by the processor 230 and may refer to a data processing device built into hardware that has a physically structured circuit to perform a function expressed by codes or commands included in the visual feature augmentation program 250 stored in the memory 240.

The embedding unit 310 may embed the class of the input image into the text space. In addition, the embedding unit 310 may embed the attribute class into the text space, formed by reflecting the attribute information onto the class. The class may be labeled for the input image.

The class may include the text information. The attribute information may include the visual information reflected in the text information. In this case, the visual information may include at least one of a size, a color, and a pattern. In addition, the attribute class may be pre-input by reflecting the attribute information.

The difference vector calculation unit 320 may calculate the difference vector between the embedded vector of the class and the embedded vector of the attribute class.

The visual feature extraction unit 330 may extract the visual feature from the input image.

The projection unit 340 may project the difference vector into the visual space.

The projection unit 340 may linearly project the difference vector into the visual space.

The visual feature augmentation unit 350 may augment the visual feature corresponding to the input image based on the difference vector.

The visual feature augmentation unit 350 may augment the visual feature using the difference vector projected by the projection unit 340. For example, the visual feature augmentation unit 350 may augment the visual feature by adding a value obtained by multiplying the projected difference vector by a weight to the visual feature.

The visual feature augmented by the visual feature augmentation unit 350 may be determined as follows.

$${\hat{f}}_{I 0} = {f}_{I 0} + α \cdot proj ( {Δ}_{0 \to 1} ) \qquad [ Equation 1 ]$$

In this case, \hat{f}_{I0} denotes the augmented visual feature, f_{I0} denotes the visual feature, α denotes the weight, and proj(Δ_{0→1}) denotes the projected difference vector.

The image generation unit 360 may generate the augmented image based on the augmented visual feature and the class.

The training unit 370 may train the encoder and the predictor using the input image and the class corresponding to the input image as the label data.

In addition, the training unit 370 may also train the encoder and the predictor using the augmented image and the class corresponding to the augmented image as the label data.

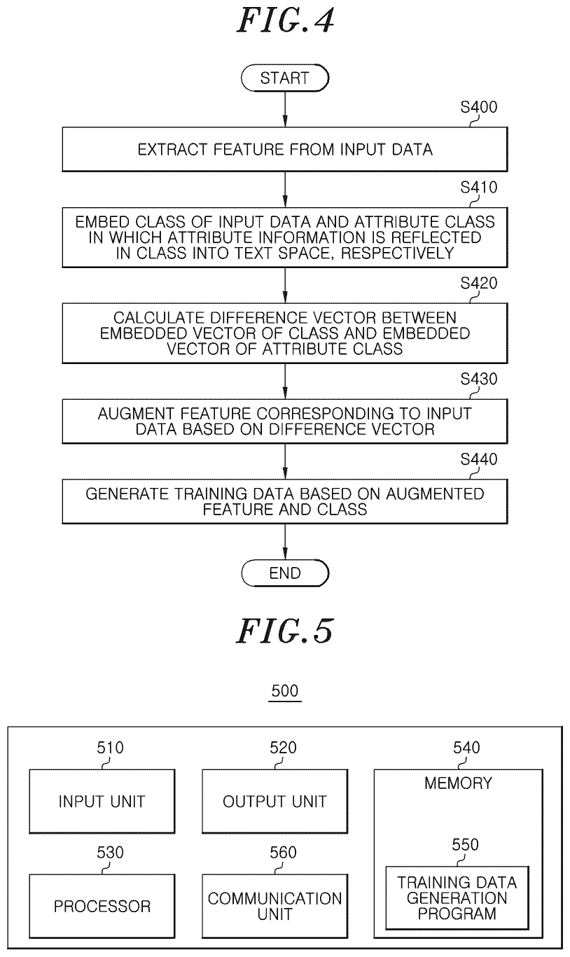

FIG. 4 is a flowchart exemplarily illustrating the method for generating training data of an AI model according to another embodiment of the first aspect of the present invention.

As illustrated in FIG. 4, the method of generating training data for an AI model performing a predetermined task according to another embodiment of the first aspect of the present invention includes a step (S400) of extracting features from input data, a step (S410) of embedding a class of the input data and an attribute class in which attribute information is reflected in the class into a text space, a step (S420) of calculating a difference vector between an embedded vector of the class and an embedded vector of the attribute class, a step (S430) of augmenting a TKDRL feature corresponding to the input data based on the difference vector, and a step (S440) of generating training data based on the augmented feature and the class.

In this case, the predetermined task may be one of image classification, object detection, and object recognition.

FIG. 5 is a block diagram exemplarily illustrating an apparatus for generating training data according to another embodiment of a second aspect of the present invention.

As illustrated in FIG. 5, the apparatus 500 for generating training data may include an input unit 510, an output unit 520, a processor 530, a memory 540, and a communication unit 560.

Hereinafter, for the convenience of description, it will be described as an example that the apparatus 500 for generating training data includes the input unit 510, the output unit 520, the processor 530, the memory 540, and the communication unit 560, but the present invention is not limited thereto. That is, each unit configuration may be provided outside the apparatus 500 for generating training data and may also operate in a manner that interacts with the apparatus 500 for generating training data.

In addition, for the same content as the apparatus 200 for augmenting a visual feature of FIG. 2, the description of the apparatus 200 for augmenting a visual feature of FIG. 2 will be applied.

The input unit 510 may include a user interface that receives commands, information, etc., that are used to control the apparatus 500 for generating training data. In addition, the input unit 510 may also be hardware devices (e.g., a keyboard, a mouse, a touch pad, etc.) that may directly receive the commands, the information, etc., that are used to control the apparatus 500 for generating training data.

In an embodiment, the input unit 510 may receive information required for the method of augmenting a visual feature from a user. Specifically, the user may input the information that includes the input data, the class, the attribute class, the training data, and the parameters related to the AI model through the input unit 510.

The output unit 520 may provide, as visual information, information that includes the input data, the class, the attribute class, the difference vector, the projected difference vector, the feature, the augmented feature, the training data, and the parameters related to the AI model, to a user through an interface or a display device.

The processor 530 may control the overall operation of the apparatus 500 for generating training data to perform the present invention.

The processor 530 may load the training data generation program 550 and information necessary for executing the training data generation program 550 from the memory 540 to execute the training data generation program 550.

The processor 530 may control the information that includes the input data, the class, the attribute class, the difference vector, the projected difference vector, the feature, the augmented feature, the training data, and the parameters related to the AI model to be transmitted and received to and from an external device through the communication unit 560.

The memory 540 may store the training data generation program 550 and the information necessary for executing the training data generation program 550. In addition, the memory 540 may also store processing results by the processor 530.

The training data generation program 550 may refer to software including instructions programmed to perform the method according to the present invention.

The memory 540 may store the information that includes the input data, the class, the attribute class, the difference vector, the projected difference vector, the feature, the augmented feature, the training data, and the parameters related to the AI model.

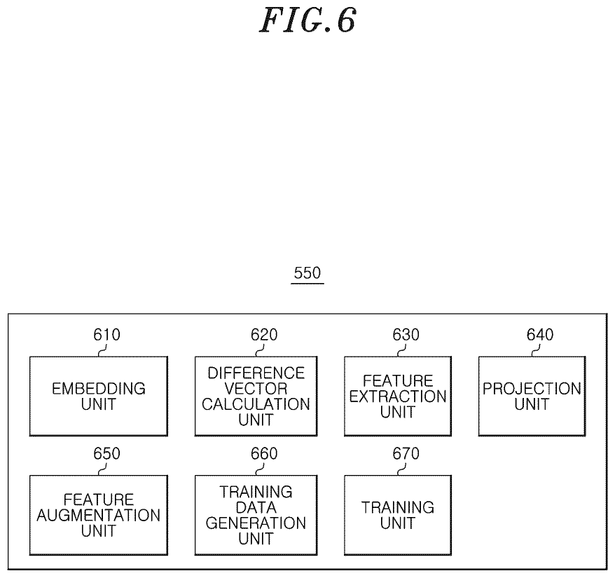

The function or operation of the training data generation program 550 will be described in detail with reference to FIG. 6.

FIG. 6 is a block diagram exemplarily illustrating the function of the training data generation program.

As illustrated in FIG. 6, the training data generation program 550 may include an embedding unit 610, a difference vector calculation unit 620, a feature extraction unit 630, a projection unit 640, a feature augmentation unit 650, a training data generation unit 660, and a training unit 670. The embedding unit 610, the difference vector calculation unit 620, the feature extraction unit 630, the projection unit 640, the feature augmentation unit 650, the training data generation unit 660, and the training unit 670 are exemplary division of dividing the functions of the training data generation program 550, but are not limited thereto.

According to an embodiment, the functions of each of the embedding unit 610, the difference vector calculation unit 620, the feature extraction unit 630, the projection unit 640, the feature augmentation unit 650, the training data generation unit 660, and the training unit 670 can be merged/separated, and may be implemented as a series of instructions included in at least one program.

The embedding unit 610, the difference vector calculation unit 620, the feature extraction unit 630, the projection unit 640, the feature augmentation unit 650, the training data generation unit 660, and the training unit 670 may be implemented by the processor 530, and may refer to a data processing device built into hardware that has a physically structured circuit to perform a function expressed by codes or commands included in the training data generation program 550 stored in the memory 540.

In addition, for the same content as the visual feature augmentation program 250 of FIG. 3, the description of the visual feature augmentation program 250 of FIG. 3 will be applied.

The embedding unit 610 may embed the class of the input data into the text space. In this case, the input data may include image data, video data, text data, and voice data, but is not limited thereto.

The feature extraction unit 630 may extract the features from the input data. Here, the features may refer to features corresponding to characteristics of the input data. For example, when the input data is the image data, the feature extraction unit 630 may extract the visual feature from the input data.

The projection unit 540 may project the difference vector into the space corresponding to the input data. For example, when the input data is the image data, the projection unit 540 may project the difference vector into the visual space.

The feature augmentation unit 650 may augment the features corresponding to the input data based on the difference vector. For example, when the input data is the image data, the feature augmentation unit 650 may augment the visual feature corresponding to the input image based on the difference vector.

The feature augmentation unit 650 may augment the features based on the difference vector projected by the projection unit 540 and the features.

The feature augmentation unit 650 may augment the features based on a value obtained by multiplying a weight by the projected difference vector and the features.

The training data generation unit 660 may generate the training data of the AI model that performs a predetermined task based on the augmented features and the classes. Here, the predetermined task may be one of the image classification, the object detection, and the object recognition. For example, the AI model may be configured to perform image search or object recognition that adapt to varying environments, such as lighting conditions and backgrounds, enabling it to recognize objects despite changes in appearance. For another example, the AI model may be capable of real-time facial recognition and transformation, improving face recognition under various angles and lighting conditions, allowing it to apply real-time filters and virtual accessories for an interactive and personalized experience. For another example, the AI model may enhance its training by augmenting visual data of road signs, lane markings, pedestrians, and other elements under various conditions, enabling it to provide safe driving assistance services.

The training unit 670 may train the AI model using the input data and the class corresponding to the input data as the label data.

In addition, the training unit 670 may train the AI model using the training data and the class corresponding to the training data as the label data.

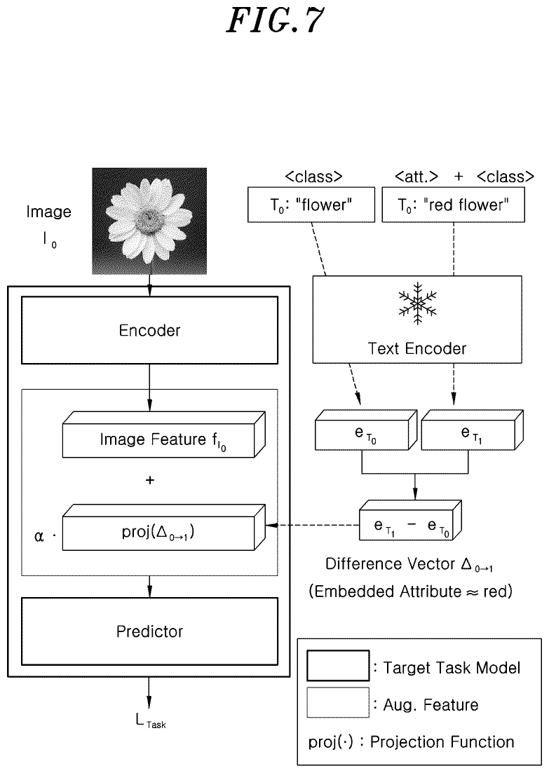

FIG. 7 is an exemplary diagram illustrating a pipeline that performs the method of augmenting a visual feature of the present invention.

As illustrated in FIG. 7, the pipeline that performs the method of augmenting a visual feature of the present invention may include an encoder, a predictor, and a text encoder.

According to the pipeline that performs the method of augmenting a visual feature of FIG. 7, a target feature space may be enriched semantically by adding the difference vector including interpretable text information to the visual feature vector corresponding to the input image.

Given an input image I₀ and a class T₀ of the input image, an attribute class T₁, which is a transformed text, may be constructed by adding the attribute text in which the attribute information is reflected. Embeddings e_{T0} and e_{T1} of T₀ and T₁ may be calculated through the text encoder, and a difference vector Δ_{0→1}=e_{T1}−e_{T0} of the two embeddings in the text space may be projected into the visual space through a function proj( ) The visual feature vector may be augmented by adding a value obtained by multiplying a weight α by the projected value to a visual feature f_{I0}.

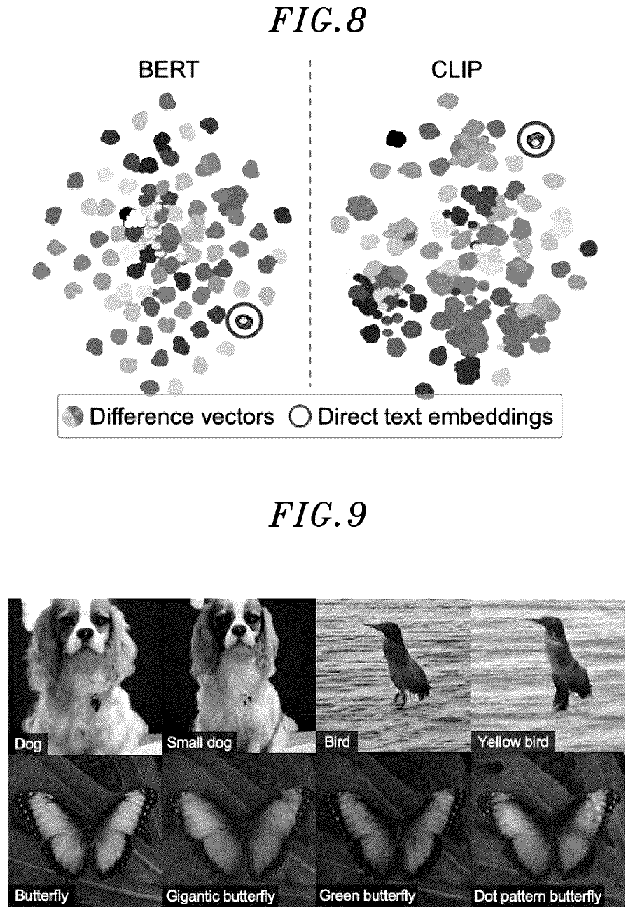

FIG. 8 is an exemplary diagram that visualizes and illustrates the difference vector representing various attributes when the difference vector is projected into the visual space.

According to FIG. 8, when the difference vector, which is the embedding difference between the existing class and the attribute class in which the attribute information is reflected, is projected into the visual space, it can be seen that the visual vector represents various attributes of the visual space.

A color of a point in FIG. 8 represents a color attribute used in the attribute text. A point inside a circle illustrated in FIG. 8 represents a feature vector that directly projects the color attribute into the visual space, not the difference vector. Therefore, when comparing the case where the difference vector is projected into the visual space and the case where the color attribute is directly projected into the visual space, it can be seen that the difference vector represents more diverse attributes than the direct text embedding. In other words, the difference vector may include contextual meaning.

For example, the difference vector calculated through “‘red cow’-‘cow’” may include the meaning of red that modifies cow. On the other hand, the text embedding for “red” may only include the meaning of the noun red.

Therefore, the meaningful data augmentation can be achieved by injecting semantic perturbation through the difference vector including the contextual meaning.

FIG. 9 is an exemplary diagram illustrating the visualization of the semantic perturbation of the method of augmenting a visual feature according to the present invention through image manipulation.

Referring to FIG. 9, it can be seen how the difference vector including specific attribute information changes an original image. It can be seen that a puppy picture in FIG. 9 changes into a small puppy through the difference vector. In this way, it can be seen that the difference vector includes the information “small.”

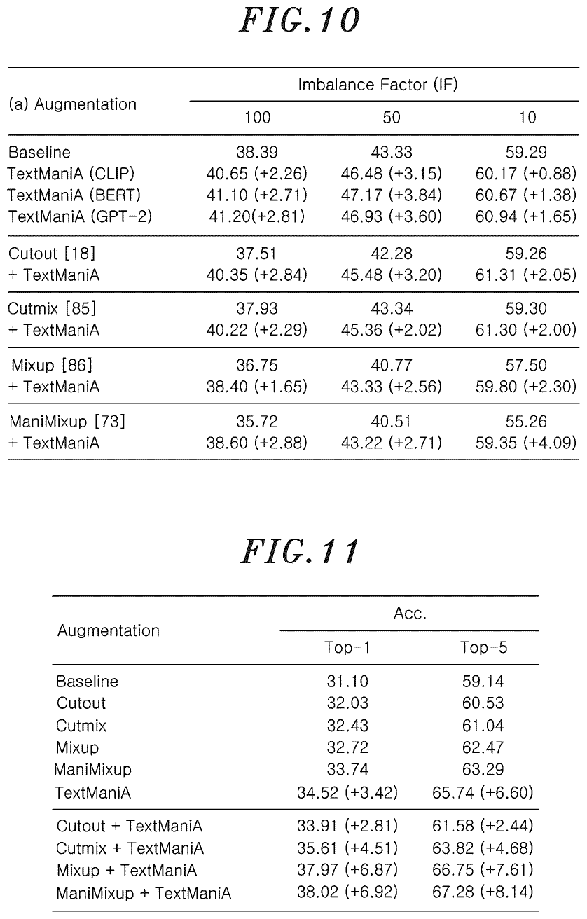

FIG. 10 is a table showing the image classification performance for a case of a long-tailed distribution with an imbalanced class-specific training data.

An imbalance factor (IF) at the top of FIG. 10 is a numerical value that indicates how imbalanced the training data distribution is. The larger the value, the more unbalanced it is. Referring to FIG. 10, it can be seen that the image classification performance is higher when the present invention (TextManiA) is applied compared to the existing interpolation-based method. In addition, it can be seen that the classifier is trained robustly even when the level of imbalance of the training data distribution is higher while the IF increases to 10, 50, and 100, that is, when it is difficult for the training data to follow the long-tailed distribution.

FIG. 11 is an exemplary diagram illustrating the image classification performance when the training data distribution is even but the number is small.

Referring to FIG. 11, it can be seen that the image classification performance and accuracy are the highest when the present invention (TextManiA) is applied compared to the existing interpolation-based method, and the classifier may be further improved through the combination with the interpolation-based method.

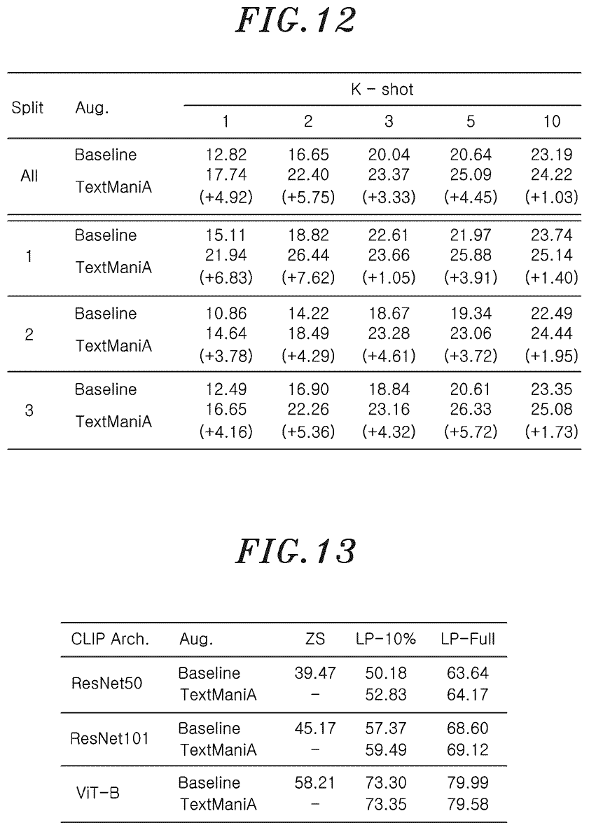

FIG. 12 is a table showing the object detection performance when the number of samples is very small, from 1 to 10.

It can be seen that the object detection performance is improved when the present invention (TextManiA) is applied in all cases where the number of samples is from 1 to 10, compared to when the data augmentation is not performed. Therefore, it can be seen that the present invention may be effectively applied to the object detection task.

FIG. 13 is a table showing the classification performance results when linearly probing the classifier of the pre-trained model on new data generated according to the method of augmenting a visual feature according to the present invention.

It can be seen that not only a model that is trained from the beginning using new data generated according to the method of augmenting a visual feature according to the present invention, but also a case where only the classifier of the pre-trained model is re-trained may obtain the performance improvement.

Combinations of steps in each flowchart attached to the present disclosure may be executed by computer program instructions. Since the computer program instructions can be mounted on a processor of a general-purpose computer, a special purpose computer, or other programmable data processing equipment, the instructions executed by the processor of the computer or other programmable data processing equipment create a means for performing the functions described in each step of the flowchart. The computer program instructions can also be stored on a computer-usable or computer-readable storage medium which can be directed to a computer or other programmable data processing equipment to implement a function in a specific manner. Accordingly, the instructions stored on the computer-usable or computer-readable recording medium can also produce an article of manufacture containing an instruction means which performs the functions described in each step of the flowchart. The computer program instructions can also be mounted on a computer or other programmable data processing equipment. Accordingly, a series of operational steps are performed on a computer or other programmable data processing equipment to create a computer-executable process, and it is also possible for instructions to perform a computer or other programmable data processing equipment to provide steps for performing the functions described in each step of the flowchart.

In addition, each step may represent a module, a segment, or a portion of codes which contains one or more executable instructions for executing the specified logical function(s). It should also be noted that in some alternative embodiments, the functions mentioned in the steps may occur out of order. For example, two steps illustrated in succession may in fact be performed substantially simultaneously, or the steps may sometimes be performed in a reverse order depending on the corresponding function.

The above description is merely exemplary description of the technical scope of the present disclosure, and it will be understood by those skilled in the art that various changes and modifications can be made without departing from original characteristics of the present disclosure. Therefore, the embodiments disclosed in the present disclosure are intended to explain, not to limit, the technical scope of the present disclosure, and the technical scope of the present disclosure is not limited by the embodiments. The protection scope of the present disclosure should be interpreted based on the following claims and it should be appreciated that all technical scopes included within a range equivalent thereto are included in the protection scope of the present disclosure.

What is claimed is:

1. A method for augmenting a visual feature performed by a visual feature augmentation apparatus, comprising:
extracting a visual feature from an input image;
embedding into a text space respectively, a class of the input image and an attribute class formed by reflecting attribute information onto the class;
calculating a difference vector between an embedded vector of the class and an embedded vector of the attribute class; and
augmenting the visual feature corresponding to the input image based on the difference vector,
wherein the apparatus includes:
an encoder that extracts the visual feature from the input image; and
a predictor that generates predicted class of the input image based on the augmented the visual feature in order to compare whether the predicted class is matched with the class of the input image.

2. The method of claim 1, further comprising:
projecting the difference vector into a visual space,
wherein, in the augmenting, the visual feature is augmented using the projected difference vector.

3. The method of claim 2, wherein, in the projecting, the difference vector is linearly projected into the visual space.

4. The method of claim 2, wherein, in the augmenting, the visual feature is augmented based on a value obtained by multiplying the projected difference vector by a weight and the visual feature.

5. The method of claim 4, wherein the augmented visual feature is determined as \hat{f}_{I0}=f_{I0}+α·proj(Δ_{0→1})
here, \hat{f}_{I0} denotes the augmented visual feature, f_{I0} denotes the visual feature, α denotes the weight, and proj(Δ_{0→1}) denotes the projected difference vector.

6. The method of claim 1, wherein the class includes text information, and the attribute information includes visual information reflected in the text information.

7. The method of claim 6, wherein the visual information includes at least one of a size, a color, and a pattern.

8. The method of claim 1, further comprising:
prior to the embedding, receiving the attribute class in which the attribute information is reflected.

9. The method of claim 1, wherein the encoder and the predictor are pre-trained using the input image and the class corresponding to the input image as label data.

10. The method of claim 1, further comprising:
generating an augmented image based on the augmented visual feature and the class.

11. The method of claim 10, further comprising:
training at least one of the encoder and the predictor using the augmented image and the class corresponding to the augmented image as label data.

12. An apparatus for augmenting a visual feature, the apparatus comprising:
a memory storing computer-executable instructions; and
a processor for executing the instructions to:
extract a visual feature from an input image;
embed into a text space respectively, a class of the input image and an attribute class formed by reflecting attribute information onto the class;
calculate a difference vector between an embedded vector of the class and an embedded vector of the attribute class; and
augment the visual feature corresponding to the input image based on the difference vector,
wherein the apparatus further includes:
an encoder that extracts the visual feature from the input image; and
a predictor that generates predicted class of the input image based on the augmented the visual feature in order to compare whether the predicted class is matched with the class of the input image.

13. The apparatus of claim 12, the processor is further configured to:
project the difference vector into a visual space,
wherein, in the augmenting, the visual feature is augmented using the projected difference vector.

14. The apparatus of claim 13, wherein the difference vector is linearly projected into the visual space.

15. The apparatus of claim 13, wherein the visual feature is augmented based on a value obtained by multiplying the projected difference vector by a weight and the visual feature.

16. The apparatus of claim 15, wherein the augmented visual feature is determined as \hat{f}_{I0}=f_{I0}+α·proj(Δ_{0→1})
here, \hat{f}_{I0} denotes the augmented visual feature, f_{I0} denotes the visual feature, α denotes the weight, and proj(Δ_{0→1}) denotes the projected difference vector.

17. The apparatus of claim 12, wherein the class includes text information, and
the attribute information includes visual information reflected in the text information.

18. The apparatus of claim 17, wherein the visual information includes at least one of a size, a color, and a pattern.

19. The apparatus of claim 18, the processor is further configured to:
prior to the embedding, receive the attribute class in which the attribute information is reflected.

20. A non-transitory computer-readable storage medium storing computer-executable instructions, wherein the computer-executable instructions, when executed by a processor, cause the processor to perform a method for augmenting a visual feature, the method comprising:
extracting a visual feature from an input image;
embedding into a text space respectively, a class of the input image and an attribute class formed by reflecting attribute information onto the class;
calculating a difference vector between an embedded vector of the class and an embedded vector of the attribute class; and
augmenting the visual feature corresponding to the input image based on the difference vector,
wherein the apparatus includes:
an encoder that extracts the visual feature from the input image; and
a predictor that generates predicted class of the input image based on the augmented the visual feature in order to compare whether the predicted class is matched with the class of the input image.
